(19) United States
(12) Patent Application Publication
(10) Pub. No.: US 2015/0243064 A1
(43) Pub. Date: Aug. 27, 2015

(54) Information Displaying Method, and electronic Device Implementing the Same

(71) Applicant: Mitac International Corp., Taoyuan City (TW)

(72) Inventor: Kuan-Hung Yeh, Taipei City (TW)

(21) Appl. No.: 14/630,955

(22) Filed: Feb. 25, 2015

(30) Foreign Application Priority Data
Feb. 26, 2014 (TW) 103106544

(51) Int. Cl. G06T 11/60

(52) U.S. Cl. CPC G06T 11/60

(57) ABSTRACT

An information displaying method using an electronic device includes: receiving a measured value that is associated with exercise of a user; determining whether or not a difference between the measured value and a reference value is greater than a predetermined threshold value; displaying the measured value in an original font when the determination made in the determining step is not affirmative; and displaying the measured value in an eye-catching font that is visually distinguishable from the original font when the determination made in the determining step is affirmative.

### CROSS-REFERENCE TO RELATED APPLICATION

This application claims priority to Taiwanese Application No. 103106544, filed on Feb. 26, 2014.

### BACKGROUND OF THE INVENTION

1. Field of the Invention

The invention relates to an information displaying method, and more particularly to an information displaying method by varying a font used for display, and an electronic device implementing the information displaying method.

2. Description of the Related Art

Conventional GPS (global positioning system) sports watches are able to measure a variety of exercise information, and to display information required and selected by users, so that the users may be made instantly aware of the information during exercise and adjust exercise conditions accordingly. For example, a runner may require to see the information of a running speed (e.g., in a form of a required time length per kilometer), a heart rate, etc., and then adjusts the exercise pace when the running speed is too fast or too slow. However, since the GPS sports watches usually do not have a big screen and the users maybe swaying during exercise, the users may be required to stare at the screen for a period of time in order to clearly obtain the information displayed on the screen, thereby disturbing exercise rhythm.

### SUMMARY OF THE INVENTION

Therefore, an object of the present invention is to provide an information displaying method that may clearly show variation of information, thereby assisting a user in being made aware of the variation with a quick glance.

According to one aspect of the present invention, an information displaying method is to be implemented using an electronic device that includes a measuring unit, a display unit and a processing unit coupled to the measuring unit and the display unit. The information displaying method comprises the steps of:

receiving, by the processing unit, a measured value that is obtained by the measuring unit measuring information associated with exercise of a user;

determining, by the processing unit, whether or not a difference between the measured value and reference value is greater than a predetermined threshold value;

displaying, by the display unit, the measured value in an original font when the determination in the determining step is not affirmative; and

displaying, by the display unit, the measured value in an eye-catching font that is visually distinguishable from the original font when the determination made in the determining step is affirmative.

Another object of the present invention is to provide an electronic device that implements the information displaying method of the present invention.

According to another aspect of the present invention, an electronic device is provided for use during exercise of a user. The electronic device comprises:

a measuring unit configured to measure information associated with the exercise of the user, and to generate a measured value;

a display unit; and

a processing unit electrically coupled to the measuring unit and the display unit, receiving the measured value from the measuring unit, and configured to determine whether or not a difference between the measured value and a reference value is greater than a predetermined threshold value,

wherein the processing unit causes the display unit to display the measured value in an original font when the processing unit determines that the difference between the measured value and the reference value is not greater than the predetermined threshold value, and to display the measured value in an eye-catching font that is visually distinguishable from the original font when the processing unit determines that the difference between the measured value and the reference value is greater than the predetermined threshold value.

### BRIEF DESCRIPTION OF THE DRAWINGS

Other features and advantages of the present invention will become apparent in the following detailed description of an embodiment with reference to the accompanying drawings, of which:

FIG. 1 is a block diagram illustrating an embodiment of the electronic device according to the present disclosure;

FIG. 2 is a flow chart illustrating steps of an embodiment of the information displaying method according to the present disclosure;

FIG. 3 is a schematic diagram illustrating an example of the embodiment of the information displaying method; and

FIG. 4 is a schematic diagram illustrating an example of a modification of the embodiment of the information displaying method.

### DETAILED DESCRIPTION OF THE EMBODIMENTS

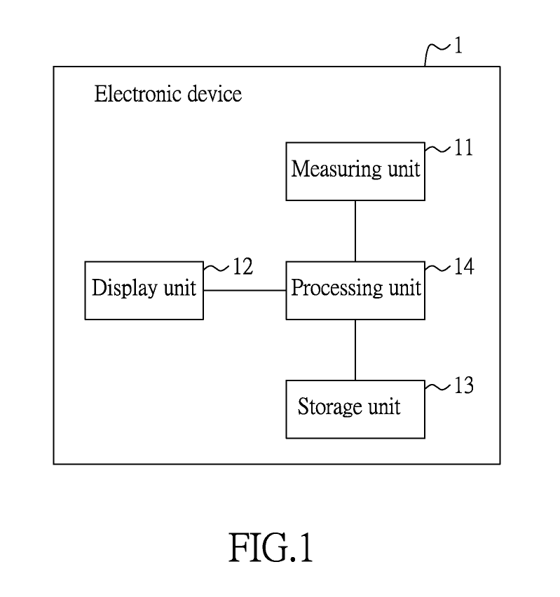

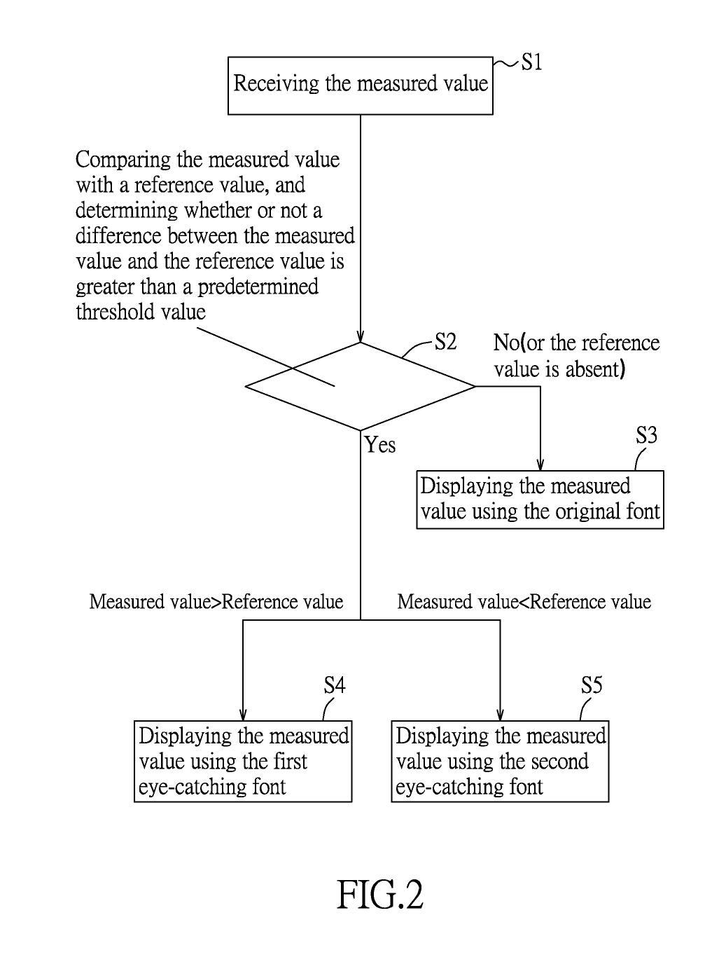

Referring to FIGS. 1 and 2, the embodiment of the information displaying method according to this disclosure is shown to be implemented using an electronic device 1 that includes a measuring unit 11, a display unit 12, a storage unit 13 and a processing unit 14 electrically coupled to the aforesaid units 11-13. The measuring unit 11 measures exercise-related information, and generates a plurality of measured values in a real-time manner. The measuring unit 11 may include a variety of measuring devices (not shown), such as a timer, a GPS sensor, a heart rate sensor, a gravity sensor, a temperature sensor, etc. The exercise-related information is information associated with exercise of a user, such as a speed, a heart rate, a distance, an ambient temperature, etc. Since the user doing exercise usually does not require precise measured values of the exercise-related information but may require tendencies of variations of the measured values, the present disclosure employs obvious variation of font to make the user quickly aware of variations of the measured values, thereby avoiding disturbance of exercise rhythm.

The method of this embodiment includes the following steps:

Step S1: The processing unit 14 receives the measured values from the measuring unit 11. The measured values may include a value of a required time length per kilometer, a heartbeat number per minute, distance in kilometers, and a temperature value respectively obtained by the measuring unit 11 measuring a speed of the user, a heart rate of the user, a distance and an ambient temperature. The processing unit 14 performs subsequent steps for each of the measured values.

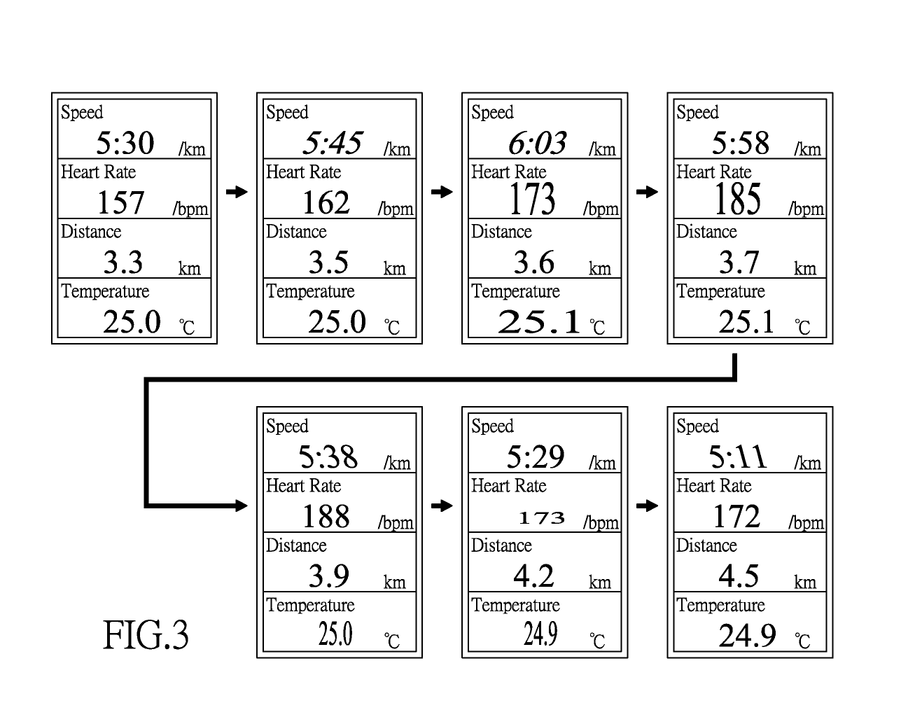

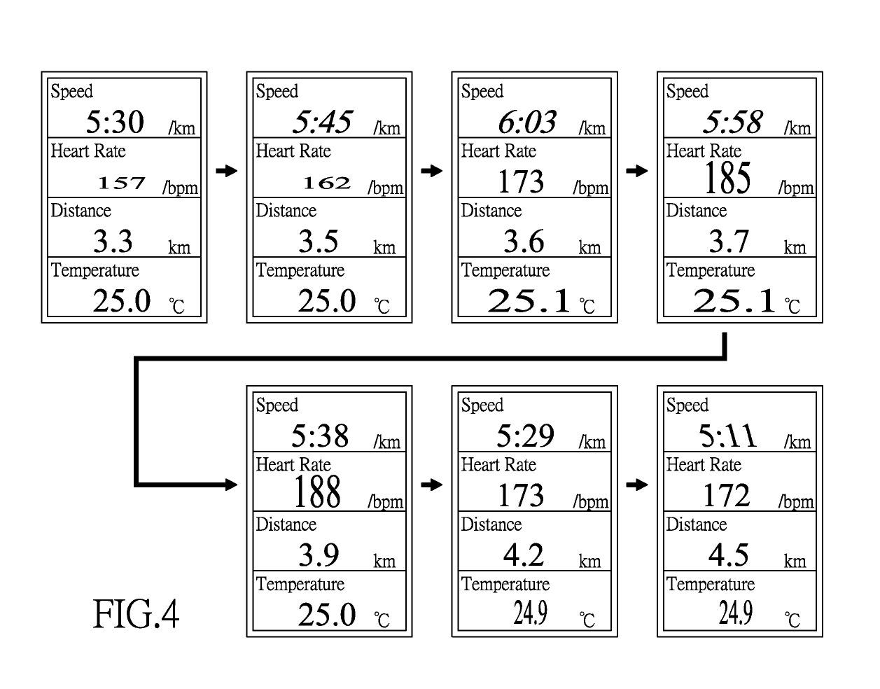

Step S2: The processing unit 14 compares the measured value with a reference value, and determines whether or not a difference between the measured value and the reference value is greater than a predetermined threshold value. The reference value may be a measured value generated by the measuring unit 11 in the last measurement (exemplified using Table 1 and FIG. 3), or a predetermined target value stored in the storage unit 13 (exemplified using Table 2 and FIG. 4). When the former serves as the reference value, the reference value may be absent (e.g., in the first measurement), and the processing unit 14 causes the display unit 12 to display the measured value in an original font. When the determination made by the processing unit 14 is not affirmative, the flow goes to step S3, in which the processing unit 14 causes the display unit 12 to display the measured value in the original font. On the other hand, when the determination made by the processing unit 14 is affirmative, the processing unit 14 causes the display unit 12 to display the measured value in an eye-catching font in the following steps.

When the determination made in step S2 is affirmative, the processing unit 14 may further determine whether the measured value is greater or smaller than the reference value. Under a condition of the measured value being greater than the reference value, the flow goes to step S4. Under a condition of the measured value being smaller than the reference value, the flow goes to step S5. In steps S4 and S5, the processing unit 14 causes the display unit 12 to display the measured value respectively in a first eye-catching font and a second eye-catching font that are visually distinguishable from the original font. For example, the original font maybe a font that stands vertically, and each of the first and second eye-catching fonts may be a font that is left-slanted or right-slanted compared to the original font. Instep S4, the processing unit 14 causes the display unit 12 to display the measured value in the first eye-catching font (e.g., a right-slanted font). In step S5, the processing unit 14 causes the display unit 12 to display the measured value in the second eye-catching font (e.g., a left-slanted font).

Referring to FIG. 2, FIG. 3 and the following Table 1, the embodiment is exemplified using a required time length per kilometer as the measured value, which is obtained by measuring the speed of the user. In this example, the reference value is a measured value of the last measurement. The measured value is displayed in a left-slanted font (second eye-catching font) when increase of the speed (i.e., decrease of the required time length per kilometer) is over a certain level, and the measured value is displayed in a right-slanted font (first eye-catching font) when decrease of the speed (i.e., increase of the required time length per kilometer) is over a certain level. The measured value is displayed in the original font (a vertically-standing font) when the variation of the speed falls within the certain levels (i.e., variation of the required time length per kilometer is smaller than the threshold value). The predetermined threshold value (T) of the example is 12 seconds (0:12).

TABLE 1

| | | | Difference | | | |
|---|---|---|---|---|---|---|
| | Measured | Reference | (D) | | M > R | |
| Cycle | value | value | between | D > T? | or | |
| No. | (M) | (R) | M and R | (T = 0:12) | M < R? | Font |
| 1 | 5:30 | — | | — | — | Original |
| 2 | 5:45 | 5:30 | 0:15 | Yes | > | Right |
| 3 | 6:03 | 5:45 | 0:18 | Yes | > | Right |
| 4 | 5:58 | 6:03 | 0:05 | No | — | Original |
| 5 | 5:38 | 5:58 | 0:20 | Yes | < | Left |
| 6 | 5:29 | 5:38 | 0:09 | No | — | Original |
| 7 | 5:11 | 5:29 | 0:18 | Yes | < | Left |

In the first measurement cycle, the processing unit 14 receives the measured value 5:30 (step S1), determines that the reference value is absent (step S2), and causes the display unit 12 to display the measured value 5:30 in the original font (step S3).

In the second measurement cycle, the measured value 5:30 of the last measurement becomes the reference value. The processing unit 14 receives the measured value 5:45 (step S1), compares the measured value 5:45 with the reference value 5:30 to obtain a difference 0:15 therebetween, determines that the difference 0:15 is greater than the threshold value 0:12, determines that the measured value 5:45 is greater than the reference value 5:30 (step S2), and causes the display unit 12 to display the measured value 5:45 in the right-slanted font (step S4).

It should be noted that, a magnitude relationship between the measured value and the reference value may be obtained when calculating the difference therebetween. The calculation of the difference may be performed by directly calculating an absolute difference therebetween (i.e., D=ABS(M−B)), or by first calculating a subtraction difference therebetween (i.e., D=(M−B) or (B−M)), and followed by obtaining an absolute value of the difference. Differences between the abovementioned two calculations may reside only in formats, such as program code appearance, stored variables, etc., but the natures of the calculations are substantially the same. In a condition of the latter, since the subtraction of the measured value and the reference value is performed first, the plus/minus sign of the subtraction difference may be used to determine the magnitude relationship. In a condition of the former, an additional inequality judgment may be used to determine the magnitude relationship (i.e., M>B? or M<B?).

In the third measurement cycle, the measured value 5:45 of the last measurement becomes the reference value. The processing unit 14 receives the measured value 6:03 (step S1), compares the measured value 6:03 with the reference value 5:45 to obtain a difference 0:18 therebetween, determines that the difference 0:18 is greater than the threshold value 0:12, determines that the measured value 6:03 is greater than the reference value 5:45 (step S2), and causes the display unit 12 to display the measured value 6:03 in the right-slanted font (step S4).

In the fourth measurement cycle, the measured value 6:03 of the last measurement becomes the reference value. The processing unit 14 receives the measured value 5:58 (step S1), compares the measured value 5:58 with the reference value 6:03 to obtain a difference 0:05 therebetween, determines that the difference 0:05 is not greater than the threshold value 0:12 (step S2), and causes the display unit 12 to display the measured value 5:58 in the original font (step S3).

In the fifth measurement cycle, the measured value 5:58 of the last measurement becomes the reference value. The processing unit 14 receives the measured value 5:38 (step S1), compares the measured value 5:38 with the reference value 5:58 to obtain a difference 0:20 therebetween, determines that the difference 0:20 is greater than the threshold value 0:12, determines that the measured value 5:38 is smaller than the reference value 5:58 (step S2), and causes the display unit 12 to display the measured value 5:38 in the left-slanted font (step S5).

In the sixth measurement cycle, the measured value 5:38 of the last measurement becomes the reference value. The processing unit 14 receives the measured value 5:29 (step S1), compares the measured value 5:29 with the reference value 5:38 to obtain a difference 0:09 therebetween, determines that the difference 0:09 is not greater than the threshold value 0:12 (step S2), and causes the display unit 12 to display the measured value 5:29 in the original font (step S3).

In the seventh measurement cycle, the measured value 5:29 of the last measurement becomes the reference value. The processing unit 14 receives the measured value 5:11 (step S1), compares the measured value 5:11 with the reference value 5:29 to obtain a difference 0:18 therebetween, determines that the difference 0:18 is greater than the threshold value 0:12, determines that the measured value 5:11 is smaller than the reference value 5:29 (step S2), and causes the display unit 12 to display the measured value 5:11 in the left-slanted font (step S5).

Briefly, when the variation of the speed is greater than 0:12, the left-slanted font is used for display while the speed becomes faster, and the right-slanted font is used for display while the speed becomes slower.

Display of the measured results of the heart rate and the ambient temperature may be similar to the aforementioned embodiment for the speed. Regarding the heart rate, the measured value is represented by bpm (beats per minute), the first eye-catching font is taller than the original font (used when the heart rate becomes faster), the second eye-catching font is shorter than the original font (used when the heart rate becomes slower), and the predetermined threshold value is 6 bpm. Regarding the ambient temperature, the measured value is represented by Celsius (° C.), the first eye-catching font is wider than the original font (used when the ambient temperature rises), and the second eye-catching font is slimmer than the original font (used when the ambient temperature falls). In this application, the predetermined threshold value is 0.0° C. since the variation in temperature is usually small. That is, as long as the measured temperature changes, the measured value is displayed in the eye-catching font.

Referring to FIG. 2, FIG. 4 and the following Table 2, a modification of the embodiment is similar to the aforementioned example, and is also exemplified using the required time length per kilometer as the measured value, which is obtained by measuring the speed of the user. In this example, the reference value used for comparison with each measured value is a predetermined target value that is pre-stored in the storage unit 13, but the application should not be limited in this respect. In other applications, the reference value for some measured values may be the measured value obtained in the last measurement, and the reference value for some measured values maybe the pre-stored target value. In this example, the target value is, but not limited to, a constant value. In other examples, the reference value may be a variable that responds to an exercise plan and that varies with time or other measurement values (e.g., distance). For example, the first one kilometer, the middle eight kilometers, and the last one kilometer may correspond to different target values, or, the first ten minutes, the middle forty minutes, and the last ten minutes may correspond to different target values.

TABLE 2

| | | | Difference | | | |
|---|---|---|---|---|---|---|
| | Measured | Reference | (D) | | M > R | |
| Cycle | value | value | between | D > T? | Or | |
| No. | (M) | (R) | M and R | (T = 0:12) | M < R? | Font |
| 1 | 5:30 | 5:30 | 0:00 | No | — | Original |
| 2 | 5:45 | 5:30 | 0:15 | Yes | > | Right |
| 3 | 6:03 | 5:30 | 0:33 | Yes | > | Right |
| 4 | 5:58 | 5:30 | 0:28 | Yes | > | Right |
| 5 | 5:38 | 5:30 | 0:08 | No | — | Original |
| 6 | 5:29 | 5:30 | 0:01 | No | — | Original |
| 7 | 5:11 | 5:30 | 0:19 | Yes | < | Left |

In this example, the target value is 5:30, and the threshold value is 0:12. Accordingly, each of the measured values that is greater than 5:42 (5:30+0:12) is displayed in the right-slanted font, each of the measured values that is smaller than 5:18 (5:30−0:12) is displayed in the left-slanted font, and the remaining measured values are displayed in the original font. Regarding the measurements of the heart rate and the ambient temperature in this example, the target value and the threshold value of the heart rate are 170 bpm and 6 bpm, respectively, and the target value and the threshold value of the ambient temperature are 25° C. and 0.0° C., respectively. Regarding the measurement of the distance in this example, the basis value is not set, and the measured value is displayed in the original font all of the time. Display of each of the abovementioned measured values is shown in FIG. 4.

In summary, the present disclosure may enable the user to be quickly aware of variation of the measured value with a glance since the measured value whose variation is greater than a corresponding threshold value is displayed in an eye-catching font, which has an apparent visual difference from the original font used for displaying the measured value that has a variation not greater than the threshold value.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An information displaying method to be implemented in an electronic device that includes a measuring unit, a display unit and a processing unit electrically coupled to the measuring unit and the display unit, said information displaying method comprising the steps of:
receiving, by the processing unit, a measured value obtained by the measuring unit measuring information associated with exercise of a user;
determining, by the processing unit, whether or not a difference between the measured value and a reference value is greater than a predetermined threshold value;
displaying, by the display unit, the measured value in an original font when the determination in the determining step is not affirmative; and
displaying, by the display unit, the measured value in an eye-catching font that is visually distinguishable from the original font when the determination made in the determining step is affirmative.

2. The information displaying method as claimed in claim 1, wherein the reference value is a previously obtained value obtained by the measuring unit.

3. The information displaying method as claimed in claim 1, wherein the reference value is a predetermined value.

4. The information displaying method as claimed in claim 1, wherein:
the eye-catching font is selected from the group consisting of a first eye-catching font and a second eye-catching font; and
when the determination in the determining step is affirmative, the displaying step includes:
displaying, by the display unit, the measured value in the first eye-catching font when the measured value is greater than the reference value; and
displaying, by the display unit, the measured value in the second eye-catching font when the measured value is smaller than the reference value.

5. The information displaying method as claimed in claim 4, wherein one of the first eye-catching font and the second eye-catching font is left-slanted compared to the original font, and the other one of the first eye-catching font and the second eye-catching font is right-slanted compared to the original font.

6. The information displaying method as claimed in claim 5, wherein:
the information measured by the measuring unit is associated with a speed of the user, and the measured value represents a required time length per unit distance;
the first eye-catching font is right-slanted compared to the original font; and
the second eye-catching font is left-slanted compared to the original font.

7. The information displaying method as claimed in claim 4, wherein one of the first eye-catching font and the second eye-catching font is taller than the original font, and the other one of the first eye-catching font and the second eye-catching font is shorter than the original font.

8. The information displaying method as claimed in claim 7, wherein:
the information measured by the measuring unit is associated with a heart rate of the user, and the measured value represents a heartbeat number per unit time length;
the first eye-catching font is taller than the original font; and
the second eye-catching font is shorter than the original font.

9. The information displaying method as claimed in claim 4, wherein one of the first eye-catching font and the second eye-catching font is wider than the original font, and the other one of the first eye-catching font and the second eye-catching font is slimmer than the original font.

10. The information displaying method as claimed in claim 9, wherein:
the information measured by the measuring unit is associated with an ambient temperature, and the measured value represents a temperature value of the ambient temperature;
the first eye-catching font is wider than the original font; and
the second eye-catching font is slimmer than the original font.

11. An electronic device for use during exercise of a user, comprising:
a measuring unit configured to measure information associated with the exercise of the user, and to generate a measured value;
a display unit; and
a processing unit electrically coupled to said measuring unit and said display unit, receiving the measured value from said measuring unit, and configured to determine whether or not a difference between the measured value and a reference value is greater than a predetermined threshold value,
wherein said processing unit is configured to cause said display unit to display the measured value in an original font when said processing unit determines that the difference between the measured value and the reference value is not greater than the predetermined threshold value, and to display the measured value in an eye-catching font that is visually distinguishable from the original font when said processing unit determines that the difference between the measured value and the reference value is greater than the predetermined threshold value.

12. The electronic device as claimed in claim 11, wherein the reference value is a previously obtained value obtained by the measuring unit measuring information associated with exercise of the user before the measuring unit measures information associated with exercise of the user for generating the measured value.

13. The electronic device as claimed in claim 11, further comprising a storage unit coupled to said processing unit and storing therein the reference value, which is a predetermined value.

14. The electronic device as claimed in claim 11, wherein:
the eye-catching font is selected from the group consisting of a first eye-catching font and a second eye-catching font; and
said processing unit is further configured to, when determining that the difference between the measured value and the reference value is greater than the predetermined threshold value, cause said display unit:
to display the measured value in the first eye-catching font when the measured value is greater than the reference value; and
to display the measured value in the second eye-catching font when the measured value is smaller than the reference value.

15. The electronic device as claimed in claim 14, wherein one of the first eye-catching font and the second eye-catching font is left-slanted compared to the original font, and the other one of the first eye-catching font and the second eye-catching font is right-slanted compared to the original font.

16. The electronic device as claimed in claim 15, wherein:
the information measured by said measuring unit is associated with a speed of the user, and the measured value represents a required time length per unit distance;
the first eye-catching font is right-slanted compared to the original font; and
the second eye-catching font is left-slanted compared to the original font.

17. The electronic device as claimed in claim 14, wherein one of the first eye-catching font and the second eye-catching font is taller than the original font, and the other one of the first eye-catching font and the second eye-catching font is shorter than the original font.

18. The electronic device as claimed in claim 17, wherein:
the information measured by said measuring unit is associated with a heart rate of the user, and the measured value represents a heartbeat number per unit time length;
the first eye-catching font is taller than the original font; and
the second eye-catching font is shorter than the original font.

19. The electronic device as claimed in claim 14, wherein one of the first eye-catching font and the second eye-catching font is wider than the original font, and the other one of the first eye-catching font and the second eye-catching font is slimmer than the original font.

20. The electronic device as claimed in claim 19, wherein:
the information measured by said measuring unit is associated with an ambient temperature, and the measured value represents a temperature value of the ambient temperature;
the first eye-catching font is wider than the original font; and
the second eye-catching font is slimmer than the original font.
